(19) United States
(12) Patent Application Publication
(10) Pub. No.: US 2003/0218767 A1
(43) Pub. Date: Nov. 27, 2003

(54) Explicit feedback for remote printing

(76) Inventors: Leonard T. Schroath, Boise, ID (US); Bradley J. Anderson, Boise, ID (US); Bruce L. Johnson, Eagle, ID (US); William I. Herrmann, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/154,889

(22) Filed: May 23, 2002

(51) Int. Cl. G06F 15/00; G06K 1/00; B41B 1/00

(52) U.S. Cl. 358/1.14

(57) ABSTRACT

A system including a client computer and a remotely networked printer provides deliberate audible feedback to a computer user regarding print jobs sent to the remote computer. The type of feedback presented is user-configurable and non-disruptive to a user's computing activities. The system is capable of providing users of remote shared printers with the same type of audible printing indications typically present when using a local personal printer.

### TECHNICAL FIELD

The present disclosure relates to document printing, and more particularly, to feedback from remote printing devices that provides users with information about when documents are printed.

### BACKGROUND

When using a personal printer that is local, as opposed to a shared printer that is remote, users can submit a print job from within an application running on their computer and observe the process of the print job transferring to the printer and being printed by the printer. Typically, shortly after a user selects the print option from within an application, a light on the printer begins blinking to indicate that the print job is in the process of being transferred. This is usually followed by familiar sounds of the printer's engine coming to life and picking up a first sheet of paper or other media on which the printer begins printing the print job.

Computer users often pause or pay particular attention after initiating a document print job to observe these familiar indications and assure themselves that their print job is actually being printed before they continue on with their computing activities. An absence of one of these familiar printing process indicators usually tells the user that the print job is not being printed and that further steps must be taken, such as reloading paper into a paper tray on the printer, fixing a paper jam on the printer, or replacing a toner cartridge in the printer.

When using shared networked printers that are remote, however, users typically have none of the same familiar indications to assure them when or if their print jobs are being printed. This lack of feedback from remote printers can be problematic for various reasons. For example, after initiating a document print job to a remote printer, a user may go to the remote printer location to retrieve the printed document and be disappointed to discover that the printed document is not available. This scenario may arise due to various circumstances, such as the remote printer having a depleted paper supply, a depleted toner supply, a paper jam, or a back-log of print jobs that are queued up to print in front of the particular user's print job. This disappointment can lead to further printing related frustration when a user prints other documents to the remote printer in the future based on the user not knowing for sure whether the print job will be ready if he/she goes to the remote printer location to retrieve the printed document.

Prior methods of alleviating this problem have fallen short of providing the sort of remote printing feedback that most users would prefer. For example, current operating system utilities usually monitor a print job's formatting process, the process of writing the job to the spooler, and the process of sending the job to the remote printer or an intermediate server. In most Windows® based operating systems, a printer icon appears in the icon tray as a print job begins spooling. A user can click on the icon and open the printer window to observe the printer status as viewed from the user's computer. The printer window will show the bytes of data from the user's print job being transferred from the user's computer. When the transfer is complete, the print job will disappear from the queue and the printer icon will vanish from the icon tray.

There are various problems with this sort of printer status utility. One of the main problems is that most users do not understand the meaning of the information provided by these utilities. For example, when the print job disappears from the queue in the print window and the printer icon vanishes from the icon tray, many users automatically assume that their print job has been sent to the remote printer and that it is being printed at that moment. However, this is misleading, because in most networked environments, the print job will likely have been spooled onto an intermediate server. The print job has simply transferred from the queue on the user's computer to a queue on a server where it must wait along with other print jobs to be printed on the same remote printer.

Therefore, if the user gets up and goes to the remote printer location to retrieve the printed document, the document may not yet be available. In addition, the various other circumstances mentioned above, such as the remote printer having a depleted paper supply, a depleted toner supply, or a paper jam, may also arise to prevent the user's print job from being available. Thus, most current printer status utilities provide no concrete information about whether print jobs sent to a remote printer are being printed or have been printed. Moreover, such utilities may actually serve to mislead uninformed users into thinking print jobs are being printed on a remote printer when in reality they are not.

Another problem is that in order to take advantage of the information being provided by current printer status utilities, a user must stop whatever computing activity he/she is doing and open up a window to observe the information. Having the utility window open in an attempt to determine the status of a print job prevents a user from working with any other computer applications. In addition, the process of the print job transferring from a user's computer to a remote server typically occurs so quickly that if the utility window is not opened soon enough, the process cannot be observed anyway. The typical result is that most users can gain little if any information about the status of print jobs they send to remote printing devices.

Another prior method of providing feedback to users on the status of print jobs sent to remote printers employs pop-up windows to inform a user when a print job has been printed. Although this method tells a user when a remotely printed job is available for pick-up, it too has disadvantages. As with the methods discussed above, a user cannot continue working on other applications when the status of the print job is being displayed in a pop-up window on the user's computer screen. Therefore, the user must close down the pop-up window to continue working on his/her computer. In addition, the pop-up window that indicates when a print job has been printed is disruptive to a user working on a computer application. Typically, user settings can be adjusted to disable the popup window, but then the user will not receive information about completed print jobs.

Accordingly, the need exists for a way to provide direct and accurate information to a user about the status of print jobs sent to remote printers that is user-friendly and non-disruptive to a user working on a computer.

### SUMMARY

A system including a computer and remote printer in a networked environment provide direct and accurate feedback to a system user regarding the status of print jobs sent to the remote printer. User-configurable audible alerts are executed on the computer or the remote printer upon the initiation or completion of the printing of a print job.

In a particular embodiment, print alert software executes on a computer to receive a print notification from a remote printer and initiate a non-disruptive audible alert through a speaker on the computer. The print alert software permits a user to configure the audible alert to provide virtually any message a user desires to inform the user when a print job has begun printing or has completed printing. The print notification is generated by print notification software executing on the remote printer.

In another embodiment, a network server acts as an intermediary between a remote printer and a client computer. The server receives a print notification from the remote printer and determines the appropriate client computer for which the print notification is destined. The server then sends the notification to the appropriate computer which initiates an audible alert through a speaker on the computer.

In still another embodiment, print notification software executes on a remote printer to initiate an audible alert on the remote printer itself that indicates when a particular print job is printing or has just finished printing. A client computer executes print alert software that transfers the audible alert to the remote printer. As in the prior embodiments, the audible alert is user-configurable. When a print job from a client computer is printing or has completed printing, the audible alert associated with that particular client computer is initiated on the printer.

### BRIEF DESCRIPTION OF THE DRAWINGS

The same reference numbers are used throughout the drawings to reference like components and features.

FIG. 1 illustrates a system environment that is suitable for providing explicit feedback for remote printing.

FIG. 2 is a block diagram illustrating in greater detail, an exemplary embodiment of a client computer and a remote printing device such as those shown in FIG. 1.

FIG. 3 is a block diagram illustrating in greater detail, an alternative exemplary embodiment of a client computer, a remote printing device, and an intermediate server such as those shown in FIG. 1.

FIG. 4 is a block diagram illustrating in greater detail, an alternative exemplary embodiment of a client computer and a remote printing device such as those shown in FIG. 1.

FIG. 5 is a flow diagram illustrating an example method of providing explicit feedback for remote printing in a system environment such as that shown in FIG. 1.

FIG. 6 is a flow diagram illustrating an alternative example method of providing explicit feedback for remote printing in a system environment such as that shown in FIG. 1.

FIG. 7 is a flow diagram illustrating another alternative example method of providing explicit feedback for remote printing in a system environment such as that shown in FIG. 1.

### DETAILED DESCRIPTION

A system including a client computer and a remotely networked printer provides deliberate audible feedback to a computer user regarding print jobs sent to the remote computer. The type of feedback presented is user-configurable and non-disruptive to a user's computing activities. The system is capable of providing users of remote shared printers with the same type of audible printing indications typically present when using a local personal printer.

Exemplary System Environment For Providing Explicit Feedback For Remote Printing

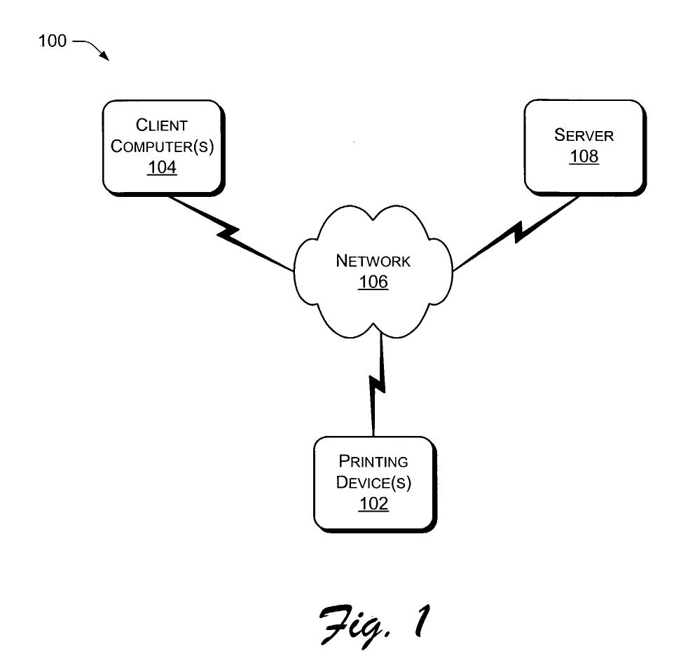

FIG. 1 illustrates an exemplary system environment that is suitable for providing explicit feedback to users regarding print jobs sent to remote printers. The exemplary system environment 100 of FIG. 1 includes printing device(s) 102 operatively coupled to a client computer 104 through a network connection 106. In addition, the system environment 100 typically includes a networked server 108. The network connection 106 can include, for example, a LAN (local area networks), a WAN (wide area networks), an intranet, the Internet, or any other suitable communication link.

This disclosure is applicable to various types of printing devices 102 capable of rendering PDL (page description language) data in printed form on a print medium, such as printing pixels on paper. Therefore, printing device 102 can include devices such as laser-based printers, ink-based printers, dot matrix printers, dry toner printers, plotters and the like. In addition, printing device 102 can include various multi-function peripheral (MFP) devices that combine a printing function with other functions such as faxing, scanning, copying and the like.

Client computer 104 can be implemented as a variety of general purpose computing devices including, for example, a personal computer (PC), a laptop computer, a palmtop computer, a Macintosh, a workstation computer, and other devices configured to communicate with printing device 102. Client computer 104 typically provides a user with the ability to manipulate or otherwise prepare in electronic form, an image or document to be rendered as an image that is printed or otherwise formed onto a print medium by printing device 102 after transmission over network 106. In general, client computer 104 outputs client data to printing device 102 in a driver format suitable for the device 102, such as PCL or PostScript. Printing device 102 converts the client data and outputs it onto an appropriate recording media, such as paper or transparencies.

Server 108 can also be implemented as a variety of general purpose computing devices such as a workstation computer or a Web server, or it might be implemented as a more specific server computer including, for example, a thin print server.

Exemplary System Embodiments For Providing Explicit Feedback For Remote Printing

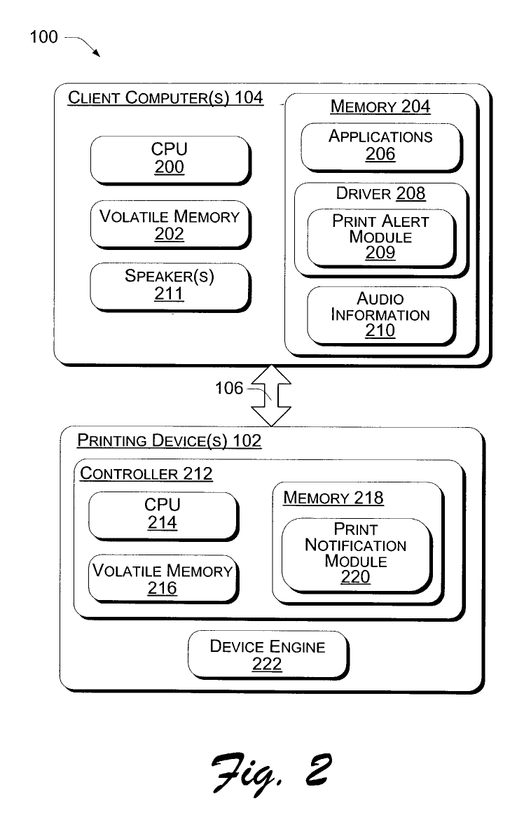

FIG. 2 is a block diagram illustrating a particular embodiment of a client computer device 104 and a remote printing device 102 as might be implemented in the system environment 100 of FIG. 1. Client device 104 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer readable instructions, data structures, program modules and other data for client device 104. Client device 104 may implement various application programs 206 stored in memory 204 and executed on processor 200 that create a document or image (e.g., text and graphics) on a computer screen that is transferable over network connection 106 to remote printing device 102 for creating a hard copy of the document/image. Such applications 206 might include software programs implementing, for example, word processors, spread sheets, browsers, multimedia players, illustrators, computer-aided design tools and the like.

Client computer 104 may also implement one or more software-based device drivers such as driver 208 that are stored in nonvolatile memory 204 and executed on processor 200. Device drivers might also be implemented on the specific devices they are “driving” such as printing device 102. In general, device driver 208 formats document information into a page description language (PDL) such as PostScript or Printer Control Language (PCL) or another appropriate format which is output to printing device 102. In addition, driver 208 includes print alert module 209 that is configured to receive a print notification from remote printing device 102 and initiate an audible alert through speaker(s) 211, informing a user as to the status of a print job as discussed more fully herein below. The audible alert is stored in memory 204 as audio information 210 and is user-configurable, also as discussed more fully herein below.

Printing device 102 includes controller 212 that, in general, processes data from client computer 104 to control the output of printing device 102 through printer device engine 222. The controller 212 typically includes a data processing unit or CPU 214, a volatile memory 216 (i.e., RAM), and a nonvolatile memory 218. Nonvolatile memory 218 can include various computer storage media such as ROM, flash memory, a hard disk, a removable floppy disk, a removable optical disk and the like. Nonvolatile memory 218 generally provides storage of computer readable instructions, data structures, program modules and other data for printing device 102.

In the exemplary embodiment of FIG. 2, printing device 102 also includes a print notification module 220 stored in memory 218. In general, print notification module 218 executes on processor 214 to provide a notification to client computer 104 when printing has begun or has been completed for a print job belonging to client computer 104.

As mentioned briefly above, print alert module 209 on client computer 104 is configured to receive a print notification from remote printing device 102 and to initiate an audible alert through speaker(s) 211. The print notification is generated by print notification module 220. Print notification module 220 is configured to monitor the processing and printing of print jobs through controller 212 and printer device engine 222. Notification module 220 determines through a client computer 104 identifier located on each print job, which client computer 104 the print job belongs to. A print notification is sent over network 106 to the appropriately identified client computer 104 when a print job has printed or has begun printing. Print notification module 220 is configurable to initiate the notification either after a print job has finished printing or as the print job begins printing.

Print alert module 209 on client computer 104 is further configured to enable a user to configure an audible alert that will be initiated when the computer 104 receives a print notification from print notification module 220 on remote printing device 102. The audible alert can be any audio information 210 that is formatted in a common digital audio file format such as WAV (wave), Real Audio, AIFF (Audio Interchange File Format) or MPEG (Motion Picture Experts Group). Print alert module 209 is generally capable of, and/or configurable for, recognizing such common digital audio file formats and converting the digital audio data into analog sound waves (i.e., analog electric signals). The analog sound waves are then converted into audible sound through speakers 211. In addition, print alert module 209 is generally capable of, and/or configurable for, receiving analog sound waves through a microphone (not shown) on computer 104 and converting the resulting analog electric signals into any common digital audio file format such as WAV, Real Audio, AIFF or MPEG. Therefore, a user can record any desired print alert message and save it as audio information 210 in a common digital audio file format.

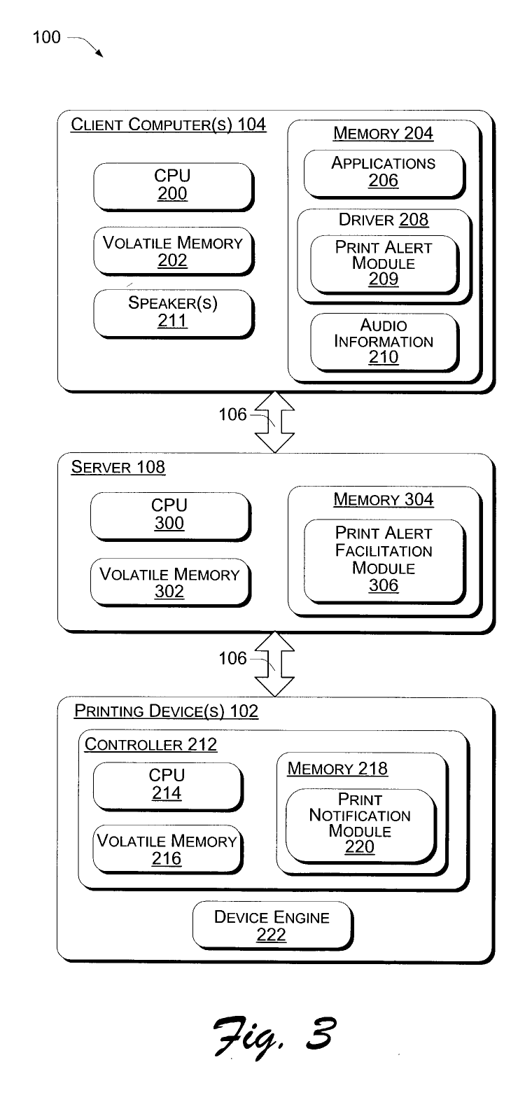

FIG. 3 is a block diagram illustrating another embodiment of a client computer device 104, a remote printing device 102, and a server 108 as might be implemented in the system environment 100 of FIG. 1. Client device 104 and remote printing device 102 are both generally configured as described above with respect to the FIG. 2 embodiment. Server 108 is generally configured in a manner similar to client device 104. Accordingly, server 108 typically includes a processor 300, a volatile memory 302 (i.e., RAM), and a nonvolatile memory 304 (e.g., ROM, hard disk, floppy disk, CD-ROM, etc.). Nonvolatile memory 304 generally provides storage of computer readable instructions, data structures, program modules and other data for server 108.

A print alert facilitation module 306 is stored in memory 306 and executable on processor 300 of server 108. The print alert facilitation module 306 is generally configured to facilitate communication between client computer 104 and remote printing device 102. Thus, instead of sending print notifications directly over the network 106 to client computer 104, remote printer 102 sends such notifications to server 108. At server 108, facilitation module 306 determines from an identifier in the notification which client computer 104 should receive the notification. The notification is then transferred to the appropriate client computer 104.

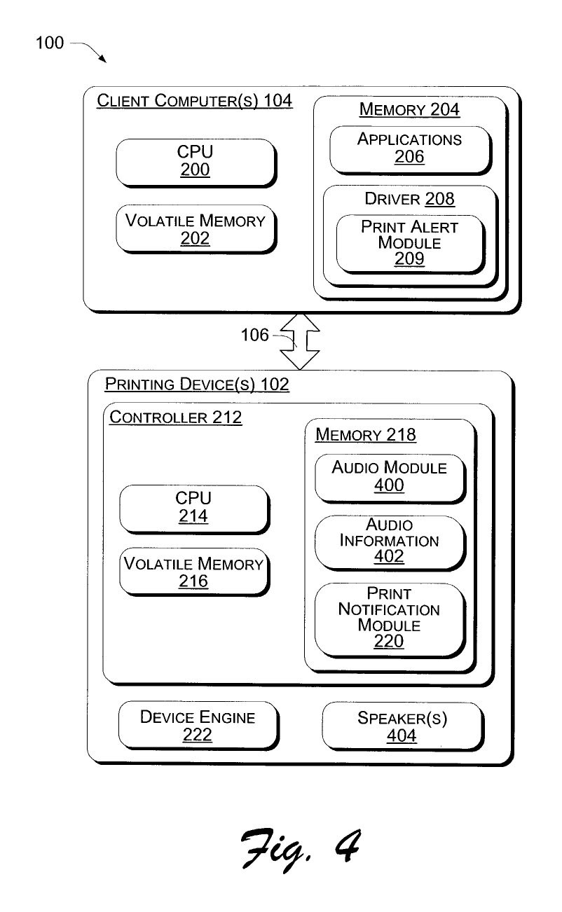

FIG. 4 is a block diagram illustrating yet another embodiment of a client computer device 104 and a remote printing device 102 as might be implemented in the system environment 100 of FIG. 1. Client device 104 and remote printing device 102 are both generally configured as described above with respect to the FIG. 2 embodiment. However, in the FIG. 4 embodiment, memory 218 of remote printing device 102 includes an audio module 400 and audio information 402.

In this embodiment, audio print alerts are initiated by print notification module 220 in a manner similar to that described above. Thus, print notification module 220 monitors the processing and printing of print jobs through controller 212 and printer device engine 222. Notification module 220 determines through a client computer 104 identifier located on each print job, which client computer 104 the print job belongs to. An audio print alert stored in audio information 402 is then associated with the client computer 104 identifier and implemented on remote printing device 102 through speaker(s) 404. As described above with respect to the print alert module 209 of FIG. 2, audio module 400 is similarly configurable to recognize common digital audio file formats such as WAV, Real Audio, AIFF and MPEG, and to convert the digital data saved in these formats into analog electric signals which are then converted into audible sound through speaker(s) 404.

In the FIG. 4 embodiment, print alert module 209 on client computer 104 is configured to send audio information to remote printing device 102 via network 106. Print alert module 209 is capable, as described above, of enabling users to record any desired print alert message and of converting such messages into a common digital audio file format such as WAV, Real Audio, AIFF or MPEG. The print alert message is sent to remote printing device 102 via network 106 where it is stored in memory 218 as audio information 402.

The FIG. 4 embodiment provides the benefit of informing one or more users waiting for print jobs to emerge from a remote printing device 102, which print job has completed printing or which print job has started printing. Users are thus spared the job of thumbing through printed pages in an output tray of printing device 102 to determine if a print job belongs to them.

Exemplary Methods For Providing Explicit Feedback For Remote Printing

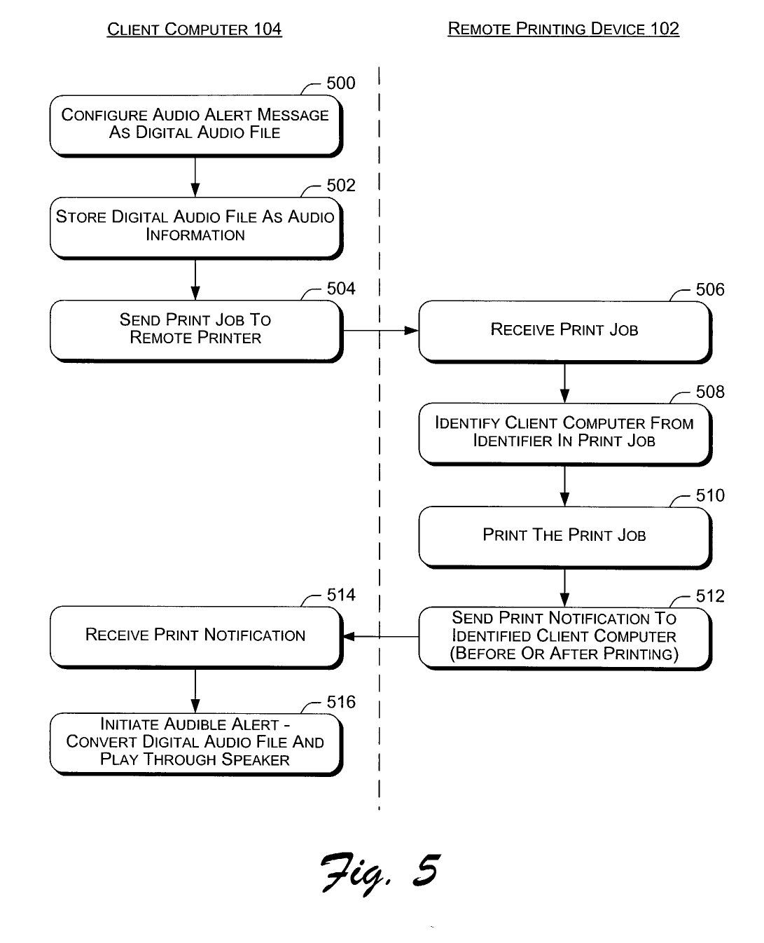

Example methods for providing explicit feedback for remote printing will now be described with primary reference to the flow diagrams of FIGS. 5, 6, and 7. The methods apply generally to the exemplary embodiments discussed above with respect to FIGS. 1-4. The elements of the described methods may be performed by any appropriate means, such as by the execution of processor-readable instructions defined on a processor-readable media, such as a disk, a ROM or other such memory device.

Referring to the method illustrated in FIG. 5, at block 500, an audio alert message is configured on a client computer 104 in a digital audio format. The audio alert message may be a pre-existing digital audio file, such as a WAV file, or it may be a message created on the client computer 104 and converted into a digital audio file in a common digital audio file format such as WAV, Real Audio, AIFF or MPEG. At block 502, the digital audio file is stored as audio information on the client computer 104. At block 504, a print job is sent from client computer 104 to remote printing device 102. At block 506, the printing device 102 receives the print job. At block 508, the printing device 102 identifies the client computer 104 based on an identifier in the print job. At block 510, the printing device 102 prints the print job.

At block 512 of FIG. 5, the printing device 102 sends a print notification to the client computer 104. This notification may be sent when the print job begins printing or after the print job has finished printing. At block 514, the client computer 104 receives the print notification. At block 516, the client computer initiates an audible alert by converting the digital audio file and playing the alert message through a speaker.

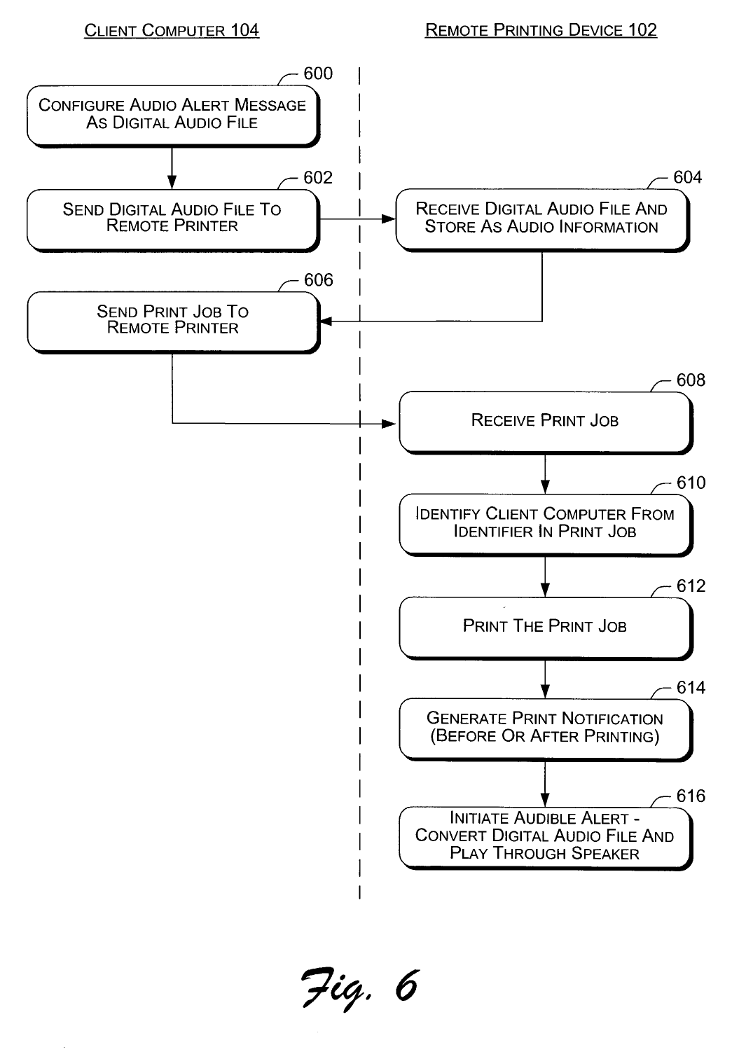

Referring to the method illustrated in FIG. 6, at block 600, an audio alert message is configured on a client computer 104 as a digital audio file in a digital audio format. The file is sent to the remote printing device 102 at block 602. At block 604, the printing device 102 receives the file and stores it as audio information. A print job is sent to printing device 102 at block 606 and received by the printing device at block 608. At block 610, the printing device 102 identifies the client computer 104 based on an identifier in the print job. At block 612, the printing device 102 prints the print job. At block 614, the printing device 102 generates a print notification which is used at block 616 to initiate an audible alert. The digital audio file corresponding to the identified client computer 104 is played through a speaker on the printing device 102.

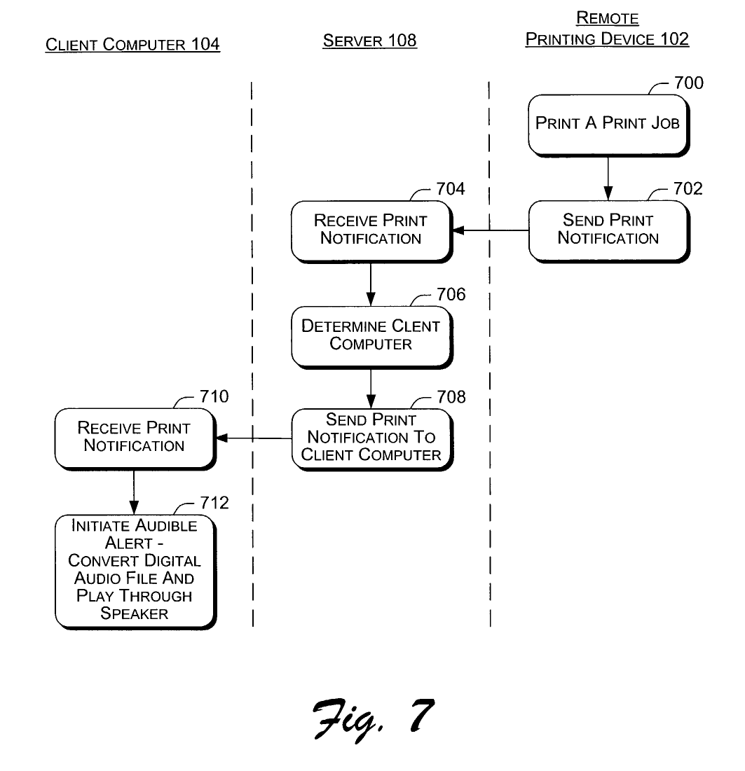

Referring to the method illustrated in FIG. 7, at block 700, remote printing device 102 prints a print job. At block 702, the printing device sends a print notification to a server 108. At block 704, the server 108 receives the print notification, and, at block 706, identifies a client computer 104 based on a client computer identifier in the print notification. The server 108 then sends the print notification to the identified client computer 104 at block 708. At block 710, the client computer 104 receives the print notification. At block 712, the client computer initiates an audible alert by converting a digital audio file and playing it through a speaker.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
receiving a print notification; and
based on the print notification, initiating an audio alert.

2. A processor-readable medium as recited in claim 1, wherein the audio alert comprises an audio file in a digital audio format, the processor-readable medium comprising further processor-executable instructions configured for:
recognizing the digital audio format;
converting the audio file into analog sound waves; and
playing the analog sound waves through a speaker.

3. A processor-readable medium as recited in claim 1, comprising further processor-executable instructions configured for enabling user configuration of the audio alert.

4. A processor-readable medium as recited in claim 1, wherein the receiving comprises receiving from a device selected from a group of devices comprising:
a network server; and
a print device.

5. A processor-readable medium comprising processor-executable instructions configured for:
receiving a print job from a client computer, the print job including a client computer identifier;
printing the print job;
identifying the client computer based on the client computer identifier on the print job;
sending a print notification to the client computer.

6. A processor-readable medium as recited in claim 5, wherein the sending occurs when the printing begins.

7. A processor-readable medium as recited in claim 5, wherein the sending occurs when the printing is completed.

8. A processor-readable medium comprising processor-executable instructions configured for:
receiving audio information from a remote computer;
receiving a print job from the remote computer;
printing the print job;
upon printing the print job, playing the audio information through a speaker.

9. A processor-readable medium as recited in claim 8, wherein the audio information comprises an audio file in a digital audio format, the processor-readable medium comprising further processor-executable instructions configured for:
recognizing the digital audio format;
converting the audio information into analog signals based on the digital audio format; and
playing the analog signals through the speaker.

10. A processor-readable medium as recited in claim 8, comprising further processor-executable instructions configured for storing the audio information as an audio information data module.

11. A processor-readable medium as recited in claim 10, wherein the print job and the audio information both include a remote computer identifier, the processor-readable medium comprising further processor-executable instructions configured for:
correlating the print job with the audio information through the remote computer identifier; and
accessing the audio information in the audio information data module.

12. A processor-readable medium comprising processor-executable instructions configured for:
receiving a print notification from a print device;
determining from the print notification, a client computer for which the print notification is destined; and
sending the print notification to the client computer.

13. A method of providing explicit feedback for remote printing comprising:
enabling a user to configure an audio print alert message as an audio file in a digital audio format;
receiving a print notification;
recognizing the digital audio format of the audio file;
converting the audio file into analog signals; and
playing the analog signals through a speaker.

14. A method of providing explicit feedback for remote printing comprising:
receiving user-configurable audio information from a remote computer;
receiving a print job from the remote computer;
printing the print job;
upon printing the print job, playing the user-configurable audio information through a speaker.

15. A method as recited in claim 14, wherein the receiving user-configurable audio information further comprises storing the user-configurable audio information in an audio information data module.

16. A method as recited in claim 15, wherein the print job and the user-configurable audio information each comprise a computer identifier, the playing further comprising:
correlating the print job with the user-configurable audio information through the computer identifier; and
accessing the user-configurable audio information in the audio information data module.

17. A computer comprising:
a processor;
a memory; and
a print alert module configured to receive a print notification and to initiate an audio alert on the computer.

18. A computer as recited in claim 17, further comprising a speaker for broadcasting the audio alert as audible sound.

19. A computer as recited in claim 17, wherein the audio alert comprises an audio file in a digital audio format selected from a group of digital audio formats comprising:
a WAV file format;
a Real Audio file format;
an AIFF file format; and
an MPEG file format.

20. A computer as recited in claim 17, wherein the print alert module is further configured to enable user configuration of the audio alert.

21. A printer for providing explicit feedback for remote printing comprising:
audio information;
a speaker; and
an audio module configured to play the audio information through the speaker when the printer prints a print job received from a computer.

22. A printer as recited in claim 21, wherein the audio information comprises user-configurable audio information received from a remote computer.

23. A server comprising:
a processor;
a memory; and
a print alert facilitation module configured to facilitate the transfer of a print notification from a print device to a client computer.

24. A system comprising:
a computer having a print alert module configured to receive a print notification from a print device and to initiate an audio alert through a speaker on the computer; and
the print device having a print notification module configured to send the print notification to the computer upon printing a print job associated with the computer.

25. A system comprising:
a computer having a print alert module executable to send user-configurable audio information to a remote print device; and
the remote print device having an audio module, audio information, and a speaker, the audio module configured to play the audio information through the speaker when the remote print device prints a print job received from the computer.

26. A system comprising:
a computer having a print alert module configured to receive a print notification and to initiate an audio alert on the computer;
the print device having a print notification module configured to send the print notification upon printing a print job for the computer; and
a server having a print alert facilitation module configured to receive the print notification from the print device and to send the print notification to the computer.
